(19) United States
(12) Patent Application Publication
(10) Pub. No.: US 2023/0229867 A1
(43) Pub. Date: Jul. 20, 2023

(54) METHOD AND SYSTEM FOR FEATURE SPECIFICATION AND DEPENDENCY INFORMATION EXTRACTION FROM REQUIREMENT SPECIFICATION DOCUMENTS

(71) Applicant: Tata Consultancy Services Limited, Mumbai (IN)

(72) Inventors: ASHA SUSHILKUMAR RAJBHOJ, Pune (IN); PADMALATA VENKATA NISTALA, Hyderabad (IN); SHIVANI SONI, Santa Clara, CA (US); VINAY KULKARNI, Pune (IN); AJIM PATHAN, Pune (IN)

(73) Assignee: Tata Consultancy Services Limited, Mumbai (IN)

(21) Appl. No.: 17/819,208

(22) Filed: Aug. 11, 2022

(30) Foreign Application Priority Data
Dec. 22, 2021 (IN) 202121059937

(51) Int. Cl. G06F 40/40; G06F 40/205; G06F 40/242; G06F 8/10

(52) U.S. Cl. CPC G06F 40/40; G06F 40/205; G06F 40/242; G06F 8/10

(57) ABSTRACT

The present disclosure provides a holistic model for feature specification and dependency representation for requirement specification documents where the conventional models fail to provide. The present disclosure receives a plurality of requirement specification documents and a related data. A product feature model is generated based on the plurality of requirement specification documents and the related data using a feature model generation technique. The product feature model includes a plurality of product feature elements. The plurality of product feature elements includes a feature area, a major feature and a plurality of features. A specification model is generated further for each of the plurality of features using a specification extraction technique. Post generating the specification model, a plurality of dependency associations are generated for each of a plurality of specification elements of the specification model using a dependency extraction technique. Finally, the plurality of dependency associations are updated in the specification model.

### PRIORITY CLAIM

This U.S. patent application claims priority under 35 U.S.C. § 119 to: Indian Patent Application No. 202121059937, filed on Dec. 22, 2021. The entire contents of the aforementioned application are incorporated herein by reference.

### TECHNICAL FIELD

The disclosure herein generally relates to the field of Natural language Processing (NLP) and, more particularly, to a method and system for feature specification and dependency extraction from requirement specification documents.

### BACKGROUND

In large-scale application development process, Software Development Life Cycle (SDLC) plays an important role. In SDLC, requirement extraction is the first step and generally, requirement specification is documented in Natural Language. For any new requirements from users, business analysts have to refer to these requirement specification documents for impact analysis and to come up with a functional solution. Knowledge of the product, functional dependencies, and so on is scattered over multiple functional documents. Many times there also exists inconsistencies across these specification documents due to human errors that complicate the business analysts' jobs. Hence a digitized requirement specification modeling is vital throughout the SDLC process.

Conventional methods such as Unified Modeling Language (UML), Business Process Model and Business Process Model and Notation (BPMN), Feature Modeling, and the like addresses a specific view and not the holistic view of the system evolution with interconnections. Also, specifying these models for large-scale product development is a tedious, time and effort consuming activity. As a result, in practice, instead of using modeling-based approaches, various product specifications documents are created as a part of requirements elicitation. These documents are maintained in diverse formats and created over many years making the requirement process manual, document-centric and SME-dependent. Hence there is a challenge in developing a holistic model for feature specification and dependency representation.

### SUMMARY

Embodiments of the present disclosure present technological improvements as solutions to one or more of the above-mentioned technical problems recognized by the inventors in conventional systems. For example, in one embodiment, a method for feature specification and dependency extraction from requirement specification documents is provided. The method includes receiving, by one or more hardware processors, a plurality of requirement specification documents, a plurality of extraction patterns, and a domain dictionary. Further, the method includes generating, by the one or more hardware processors, a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features. Furthermore, the method includes generating, by the one or more hardware processors, a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters. Further, the method includes generating, by the one or more hardware processors, a plurality of dependency associations for each of the plurality of specification elements based on the corresponding specification model using a dependency extraction technique. Finally, the method includes updating, by the one or more hardware processors, the plurality of dependency associations in the corresponding specification model.

In another aspect, a system for feature specification and dependency extraction from requirement specification documents is provided. The system includes at least one memory storing programmed instructions, one or more Input/Output (I/O) interfaces, and one or more hardware processors operatively coupled to the at least one memory, wherein the one or more hardware processors are configured by the programmed instructions to receive a plurality of extraction patterns, and a domain dictionary. Further, the one or more hardware processors are configured by the programmed instructions to generate a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features. Furthermore, the one or more hardware processors are configured by the programmed instructions to generate a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters. Furthermore, the one or more hardware processors are configured by the programmed instructions to generate a plurality of dependency associations for each of the plurality of specification elements based on the corresponding specification model using a dependency extraction technique. Finally, the one or more hardware processors are configured by the programmed instructions to update the plurality of dependency associations in the corresponding specification model.

In yet another aspect, a computer program product including a non-transitory computer-readable medium having embodied therein a computer program for feature specification and dependency extraction from requirement specification documents is provided. The computer readable program, when executed on a computing device, causes the computing device to receive a plurality of extraction patterns, and a domain dictionary. Further, the computer readable program, when executed on a computing device, causes the computing device to generate a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features. Furthermore, the computer readable program, when executed on a computing device, causes the computing device to generate a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters. Furthermore, the computer readable program, when executed on a computing device, causes the computing device to generate a plurality of dependency associations for each of the plurality of specification elements based on the corresponding specification model using a dependency extraction technique. Finally, the computer readable program, when executed on a computing device, causes the computing device to update the plurality of dependency associations in the corresponding specification model.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles:

FIG. 1 is a functional block diagram of a system for feature specification and dependency extraction from requirement specification documents, in accordance with some embodiments of the present disclosure.

FIG. 2 is an exemplary flow diagram illustrating a method for feature specification and dependency extraction from requirement specification documents, implemented by the system of FIG. 1, in accordance with some embodiments of the present disclosure.

FIG. 3 is an example product feature model for the processor implemented method for feature specification and dependency extraction from requirement specification documents implemented by the system of FIG. 1, in accordance with some embodiments of the present disclosure.

FIG. 4 is an exemplary flow diagram for specification model generation for the processor implemented method for feature specification and dependency extraction from requirement specification documents implemented by the system of FIG. 1, in accordance with some embodiments of the present disclosure.

FIGS. 5A and 5B are example feature specification model for the processor implemented method for feature specification and dependency extraction from requirement specification documents implemented by the system of FIG. 1, in accordance with some embodiments of the present disclosure.

FIGS. 6A, 6B and 6C are example dependency associations for the processor implemented method for feature specification and dependency extraction from requirement specification documents implemented by the system of FIG. 1, in accordance with some embodiments of the present disclosure.

FIG. 7 illustrates a functional architecture for the processor implemented method for feature specification and dependency extraction from requirement specification documents implemented by the system of FIG. 1, in accordance with some embodiments of the present disclosure.

FIG. 8 is an example flow diagram for query processing and output report generation for the processor implemented method for feature specification and dependency extraction from requirement specification documents implemented by the system of FIG. 1, in accordance with some embodiments of the present disclosure

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the scope of the disclosed embodiments.

Embodiments herein provide a method and system for feature specification and dependency extraction from requirement specification documents. Initially, the system receives a plurality of requirement specification documents, a plurality of extraction patterns and a domain dictionary. Further, a product feature model is generated based on the plurality of requirement specification documents, the plurality of extraction patterns and the domain dictionary using a feature model generation technique. The product feature model includes a plurality of product feature elements arranged hierarchically. The plurality of product feature elements comprises a feature area, a major feature and a plurality of features. A specification model is generated further for each of the plurality of features associated with the product feature model using a specification extraction technique. The specification model includes a plurality of specification elements and a plurality of corresponding associations. The plurality of specification elements includes a plurality of processes, a plurality of activities, a plurality of ruleset, a plurality of rules and a plurality of parameters. Post generating the specification model, a plurality of dependency associations are generated for each of the plurality of specification elements using a dependency extraction technique. Finally, the plurality of dependency associations are updated in the corresponding specification model.

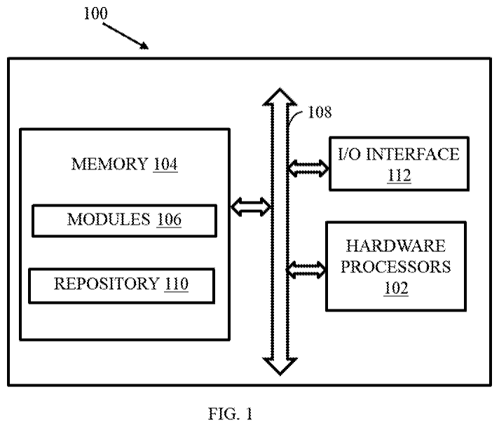

Referring now to the drawings, and more particularly to FIGS. 1 through 8, where similar reference characters denote corresponding features consistently throughout the figures, there are shown preferred embodiments and these embodiments are described in the context of the following exemplary system and/or method.

FIG. 1 is a functional block diagram of a system 100 for feature specification and dependency extraction from requirement specification documents, according to some embodiments of the present disclosure. The system 100 includes or is otherwise in communication with hardware processors 102, at least one memory such as a memory 104, an I/O interface 112. The hardware processors 102, memory 104, and the Input/Output (I/O) interface 112 may be coupled by a system bus such as a system bus 108 or a similar mechanism. In an embodiment, the hardware processors 102 can be one or more hardware processors.

The I/O interface 112 may include a variety of software and hardware interfaces, for example, a web interface, a graphical user interface, and the like. The I/O interface 112 may include a variety of software and hardware interfaces, for example, interfaces for peripheral device(s), such as a keyboard, a mouse, an external memory, a printer and the like. Further, the I/O interface 112 may enable the system 100 to communicate with other devices, such as web servers, and external databases.

The I/O interface 112 can facilitate multiple communications within a wide variety of networks and protocol types, including wired networks, for example, local area network (LAN), cable, etc., and wireless networks, such as Wireless LAN (WLAN), cellular, or satellite. For the purpose, the I/O interface 112 may include one or more ports for connecting several computing systems with one another or to another server computer. The I/O interface 112 may include one or more ports for connecting several devices to one another or to another server.

The one or more hardware processors 102 may be implemented as one or more microprocessors, microcomputers, microcontrollers, digital signal processors, central processing units, node machines, logic circuitries, and/or any devices that manipulate signals based on operational instructions. Among other capabilities, the one or more hardware processors 102 is configured to fetch and execute computer-readable instructions stored in the memory 104.

The memory 104 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 104 includes a plurality of modules 106. The memory 104 also includes a data repository (or repository) 110 for storing data processed, received, and generated by the plurality of modules 106.

The plurality of modules 106 include programs or coded instructions that supplement applications or functions performed by the system 100 for feature specification and dependency extraction from requirement specification documents. The plurality of modules 106, amongst other things, can include routines, programs, objects, components, and data structures, which performs particular tasks or implement particular abstract data types. The plurality of modules 106 may also be used as, signal processor(s), node machine(s), logic circuitries, and/or any other device or component that manipulates signals based on operational instructions. Further, the plurality of modules 106 can be used by hardware, by computer-readable instructions executed by the one or more hardware processors 102, or by a combination thereof. The plurality of modules 106 can include various sub-modules (not shown). The plurality of modules 106 may include computer-readable instructions that supplement applications or functions performed by the system 100 for feature specification and dependency extraction from requirement specification documents. In an embodiment, plurality of modules 106 includes a product feature model generation module (not shown in FIG. 1), a specification model generation module (not shown in FIG. 1), a dependency association identification module (not shown in FIG. 1) and a dependency association updation module (not shown in FIG. 1).

The data repository (or repository) 110 may include a plurality of abstracted piece of code for refinement and data that is processed, received, or generated as a result of the execution of the plurality of modules in the module(s) 106.

Although the data repository 110 is shown internal to the system 100, it will be noted that, in alternate embodiments, the data repository 110 can also be implemented external to the system 100, where the data repository 110 may be stored within a database (not shown in FIG. 1) communicatively coupled to the system 100. The data contained within such external database may be periodically updated. For example, new data may be added into the database (not shown in FIG. 1) and/or existing data may be modified and/or non-useful data may be deleted from the database (not shown in FIG. 1). In one example, the data may be stored in an external system, such as a Lightweight Directory Access Protocol (LDAP) directory and a Relational Database Management System (RDBMS).

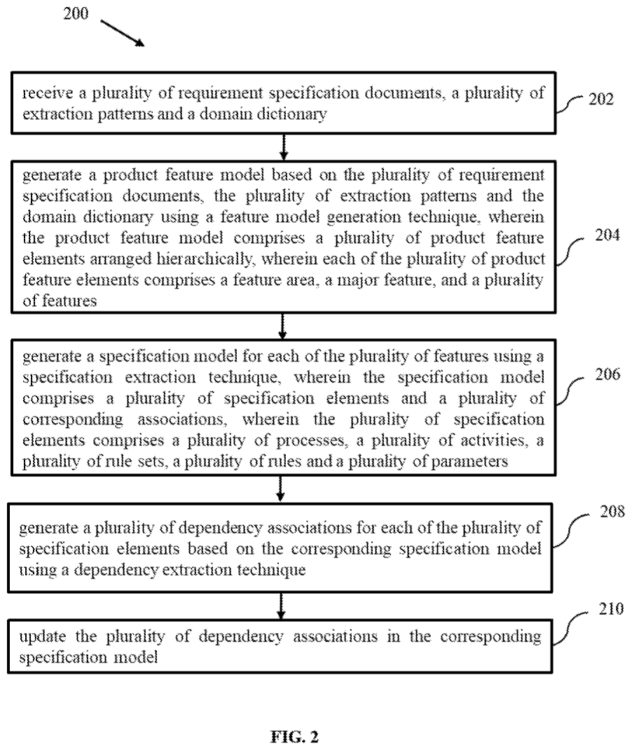

FIG. 2 is an exemplary flow diagram illustrating a method 200 for feature specification and dependency extraction from requirement specification documents implemented by the system of FIG. 1 according to some embodiments of the present disclosure. In an embodiment, the system 100 includes one or more data storage devices or the memory 104 operatively coupled to the one or more hardware processor(s) 102 and is configured to store instructions for execution of steps of the method 200 by the one or more hardware processors 102. The steps of the method 200 of the present disclosure will now be explained with reference to the components or blocks of the system 100 as depicted in FIG. 1 and the steps of flow diagram as depicted in FIG. 2. The method 200 may be described in the general context of computer executable instructions. Generally, computer executable instructions can include routines, programs, objects, components, data structures, procedures, modules, functions, etc., that perform particular functions or implement particular abstract data types. The method 200 may also be practiced in a distributed computing environment where functions are performed by remote processing devices that are linked through a communication network. The order in which the method 200 is described is not intended to be construed as a limitation, and any number of the described method blocks can be combined in any order to implement the method 200, or an alternative method. Furthermore, the method 200 can be implemented in any suitable hardware, software, firmware, or combination thereof.

At step 202 of the method 200, the one or more hardware processors 102 are configured by the programmed instructions to receive a plurality of requirement specification documents, a plurality of extraction patterns and a domain dictionary. The plurality of extraction patterns include a process pattern, an activity pattern, a parameter pattern, a ruleset pattern and a rule pattern. Each of the plurality of extraction patterns includes a corresponding plurality of document formatting styles. For example, Heading style pattern includes Heading1, Heading2, Bold, Underlined and the like. For example, the process pattern includes Heading2 with text “Main Success Scenario” or “Alternate Flow”. The activity pattern includes a plurality of Number styled text available after process. For example, “1. Perform . . . ”. The ruleset pattern includes Bold and Underlined text inside Heading2 with name “Business Rules”. The rule pattern includes Bullet styled text available after ruleset. The parameter pattern includes Tabular data available after activity. The domain dictionary includes a plurality of taxonomical variations of domain terms. For example, the terms “Business Partner”, “Shareholder”, “Trader”, “Authorized Holder”, “Direct participants” refer to the same concept.

At step 204 of the method 200, the one or more hardware processors 102 are configured by the programmed instructions to generate a product feature model based on the plurality of requirement specification documents, the plurality of extraction patterns and the domain dictionary using a feature model generation technique. The product feature model comprises a plurality of product feature elements arranged hierarchically. Each of the plurality of product feature elements are one of, a feature area, a major feature and a plurality of features. In an embodiment, the product feature model is constructed using a Natural Language Processing (NLP) based pattern matching technique. The plurality of product feature elements are identified using a plurality of corresponding patterns using NLP based pattern matching techniques. In another embodiment, the product feature model is constructed using similar other techniques.

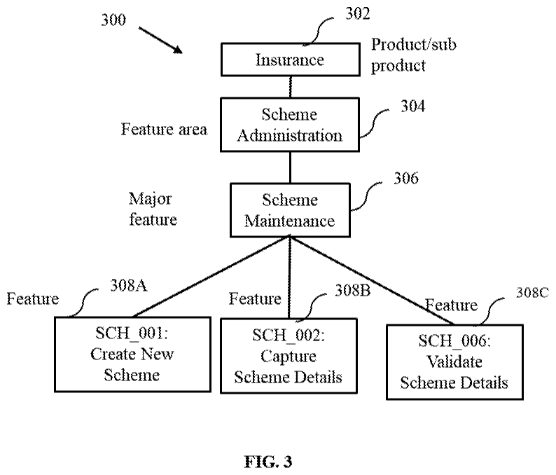

FIG. 3 is an example product feature model for the processor implemented method for feature specification and dependency extraction from requirement specification documents implemented by the system of FIG. 1, in accordance with some embodiments of the present disclosure. Now referring to FIG. 3, the product feature model 300 includes a product or subproduct name “Insurance” 302, a feature area “Scheme Administration” 304, a major feature “Scheme Maintenance” 306 and a plurality of features. The plurality of features includes “SCH_001: Create New Scheme” 308A, “SCH_002: Capture Scheme Details” 308B and “SCH_006: Validate Scheme Details” 308C. The feature type associated with the said plurality of features is an Input Output (IO) function. The other feature types includes an interface, a report and a query. Here “SCH” indicates the feature Scheme.

At step 206 of the method 200, the one or more hardware processors 102 are configured by the programmed instructions to generate a specification model for each of the plurality of features associated with the product feature model using a specification extraction technique. The specification model includes a plurality of specification elements and a plurality of corresponding associations. The plurality of specification elements includes a plurality of processes, a plurality of activities, a plurality of ruleset, a plurality of rules and a plurality of parameters. Each of the plurality of specification elements of the specification model includes a plurality of properties. The plurality of properties includes an ID, a name and a description. For example referring to FIG. 3, the “SCH_001”, “SCH_002” and “SCH_006” are ID numbers pertaining to the plurality of feature names “Create New Scheme”, “Capture Scheme Details” and “Validate Scheme Details” respectively. For example, the description for the feature “Create New Scheme” is “Create New Scheme will create new scheme for a user through GUI.”.

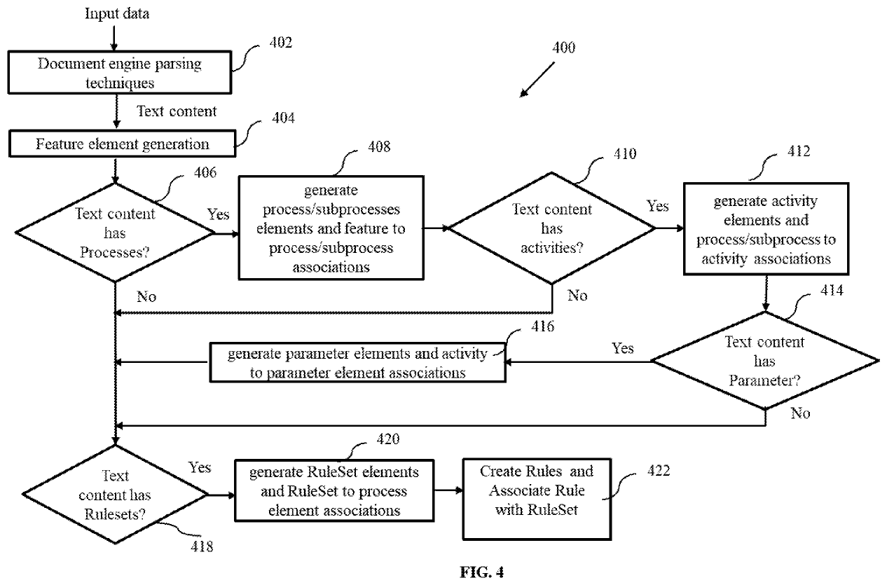

In an embodiment, the method of generating the specification model for each of the plurality of features using the specification extraction technique is explained in conjunction with FIG. 4. FIG. 4 is an exemplary flow diagram for specification model generation for the processor implemented method for feature specification and dependency extraction from requirement specification documents implemented by the system of FIG. 1, in accordance with some embodiments of the present disclosure. Now referring to FIG. 4, the plurality of features and the plurality of requirement specification documents are received as input by the method 400. Further, the plurality of requirement specification documents are parsed at step 402 to obtain a plurality of text content using a document engine parsing techniques. Further, a feature element is generated corresponding to each of the plurality of features at step 404. Further, the plurality of processes and subprocesses are identified based on a comparison between the plurality of text content and the plurality of process patterns at step 406. If no processes or subprocesses are identified, the method 400 searches for rule pattern by transferring the control to the step 418. If the plurality of processes are identified, a plurality of process elements are generated for each of the identified plurality of processes or subprocesses at step 408. Further an association is generated between each of a plurality of feature elements and each of a plurality of corresponding process elements. At step 410, the plurality of text content is checked for a plurality of activities. If the plurality of activities are identified, an activity element corresponding to each of the identified plurality of activities are generated at step 412. Further, an association between each of a plurality of subprocess elements and each of a plurality of corresponding activity elements are generated. If no activities are identified, the method 400 searches for rule pattern by transferring the control to the step 418. At step 414, the text content is checked for a plurality of parameters corresponding to each of the plurality of activities. Here, a comparison is performed between plurality of text content and a plurality of parameter patterns. If the plurality of parameters are identified, a parameter element corresponding to each of a plurality of identified parameters are generated. Further, an association between each of a plurality of activity elements and each of a plurality of corresponding parameter elements are generated. If no parameters are identified, the method 400 searches for rule pattern by transferring the control to the step 418. At step 418, it is checked whether the text content includes a plurality of rulesets based on a comparison between plurality of text content and a plurality of ruleset patterns. If a match is identified, a plurality of ruleset elements corresponding to each of the plurality of rulesets are generated at step 420. Further, an association between each of the plurality of process elements and each of a plurality of corresponding ruleset elements are generated. At step 422, a plurality of rules corresponding to each of the plurality of ruleset are extracted based on a comparison between the plurality of text content and a plurality of rule patterns. Further, a rule element is generated for the plurality of rules and an association between the rule element and the corresponding ruleset element is generated.

At step 208 of the method 200, the one or more hardware processors 102 are configured by the programmed instructions to generate a plurality of dependency associations for each of the plurality of specification elements based on the corresponding specification model using a dependency extraction technique. A dependency association indicates that an element (process or subprocess, ruleset, activity, parameter, rules) instantiates, or uses another element for completing the functionality.

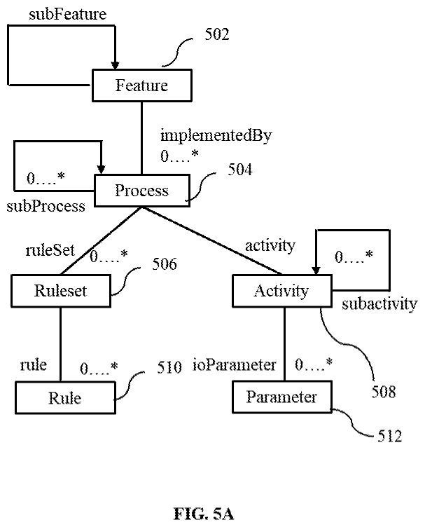

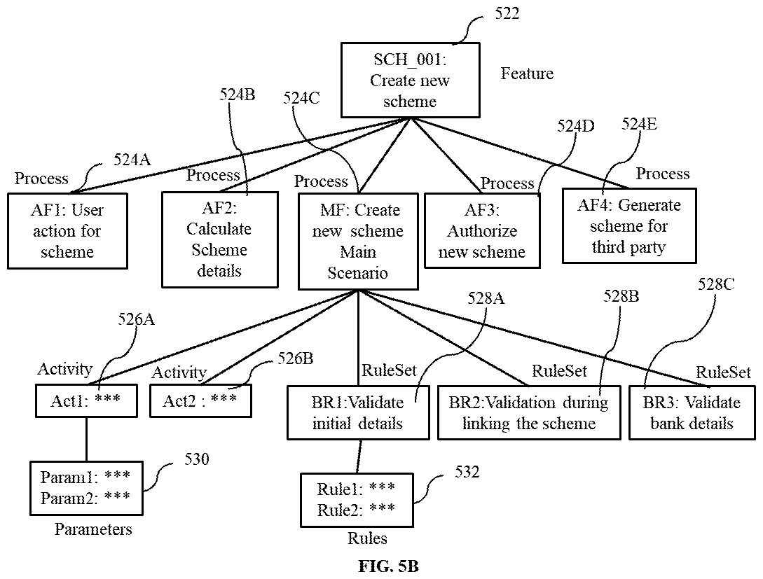

FIG. 5A is a generalized feature specification model for the processor implemented method for feature specification and dependency extraction from requirement specification documents implemented by the system of FIG. 1, in accordance with some embodiments of the present disclosure.

Now referring to FIG. 5A, the specification model comprises a plurality of specification elements including a feature 502, a process 504, a ruleset 506, an activity 508, a rule 510 and a parameter 512. The feature 502 is associated with itself for a subFeature. The feature 502 is associated with the process 504 by an association named “implementedBy”. The process 504 has two association, one is with ruleset 506 named “ruleset” and another with the activity 508 named “activity”. The process 504 is associated with itself by an association named “subProcess”. The activity is associated with itself by an association named “subActivity”. The ruleset 506 is associated with the rule 510 by the name “rule”. The activity 508 is associated with the parameter 512 by an association named “ioParameter”.

FIG. 5B is an example feature specification model for the feature element “Create new scheme” for the processor implemented method for feature specification and dependency extraction from requirement specification documents implemented by the system of FIG. 1, in accordance with some embodiments of the present disclosure.

Now referring to FIG. 5B, the specification element 522 is holding a feature “Create new scheme”. The specification element 522 includes a plurality of processes including “AF1: User action for scheme” 524A, “AF2: Calculate scheme details” 524B, “MF: Create new scheme Main Scenario” 524C, “AF3: Authorize new scheme” 524D, “AF4: Generate scheme for third party” 524E. The process 524C “Create new scheme Main Scenario” includes a plurality of activities including “Act1: ***” 526A and “Act2: ***” 526B. The process 524C “Create new scheme Main Scenario” includes a plurality of rulesets including “BR1: Validate initial details” 528A, “BR2: Validation during linking the scheme” 528B and “Validate bank details” 528C. The activity element 526A includes a plurality of parameters represented in the element 530. Further, the ruleset element 528A includes a plurality of rules represented in the specification element 532. Here “AF” indicates Alternate Flow, “MF” indicates Main Flow, “Act” indicates “Activity” and “BR” indicates Business RuleSet. The “Act1: ***” of 526A and “Act2: ***” of 526B indicates a plurality of corresponding activities of the process 524C. The “Param1: ***” and the “Param2: ***” of 530 indicates the plurality of parameters associated with the activity 526A. The “Rule1: ***” and “Rule1: ***” of 532 are the plurality of rules associated with the RuleSet 528A.

In an embodiment, the method of generating the plurality of dependency associations for each of the plurality of specification elements based on the corresponding specification model using the dependency extraction technique is explained as follows: Initially, the specification model corresponding to each of the plurality of features is received. Further, a plurality of dependencies associated with each of the plurality of specification elements are identified based on the corresponding description using a dependency searching technique by: (i) preprocessing the description by using a preprocessing technique. The preprocessing involves removal of stop words, root word formation and swapping of dictionary terms with the corresponding common names (ii) obtaining a plurality of split sentences by splitting the preprocessed description using sentence delimiter (Part of Speech) PoS tags (iii) identifying the plurality of dependencies associated with each of the plurality of specification elements based on the plurality of split sentences using a plurality of matching techniques. The plurality of matching techniques includes an ID based exact matching, a name based exact matching, a name based inexact matching and an indirect feature reference matching. Finally, the plurality of dependencies corresponding to each of the plurality of specification elements are updated in the specification model by traversing the specification model. The plurality of dependencies comprises a featureDependsOnFeature dependency, an activityInvokesProcess dependency, an activityInvokesActivity dependency, an activityInvokesRuleSet dependency, ruleInvokesOrocess dependency, ruleInvokesRuleSet dependency, a parameterComputedByProcess dependency, and a parameterValidatedByRuleSet dependency.

In an embodiment, the ID based exact matching technique compares the ID associated with each of the plurality of specification elements with the plurality split sentences corresponding to each of the plurality of specification elements. The name based exact matching technique compares the names associated with each of the plurality of specification elements with the plurality of split sentences corresponding to each of the plurality of specification elements. The name based inexact matching technique compares the name associated with each of the plurality of specification elements with the plurality of split sentences corresponding to each of the plurality of specification elements. However, the name based inexact matching ignores ordering of words associated with the name of the specification element in the preprocessed description. The indirect feature reference matching technique compares the plurality of split sentences corresponding to each of the plurality of specification elements with a plurality of feature referential words. Each of the plurality of referential words comprises a plurality of feature reference patterns. Each of the plurality of feature reference patterns includes a corresponding plurality of referencing styles. For example the plurality of referential words are “previous feature”, “section reference” and the like.

In an embodiment, the method of preprocessing is explained as follows: Initially, an input is received. In an embodiment, the input is the plurality of requirement specification documents. Further, a plurality of stop words associated with the plurality of requirement specification documents are removed using a parsing technique. After removing the stop words, a root form for each of a plurality of words associated with the parsed data are obtained using a Natural Language Processing (NLP) technique. A plurality of dictionary terms are identified simultaneously from the parsed data. Finally, each of the plurality of dictionary terms associated with the parsed data are swapped with a corresponding common name using the domain dictionary. For example, the parsed name “Direct participants” is swapped with the corresponding common name “Trader” and the like.

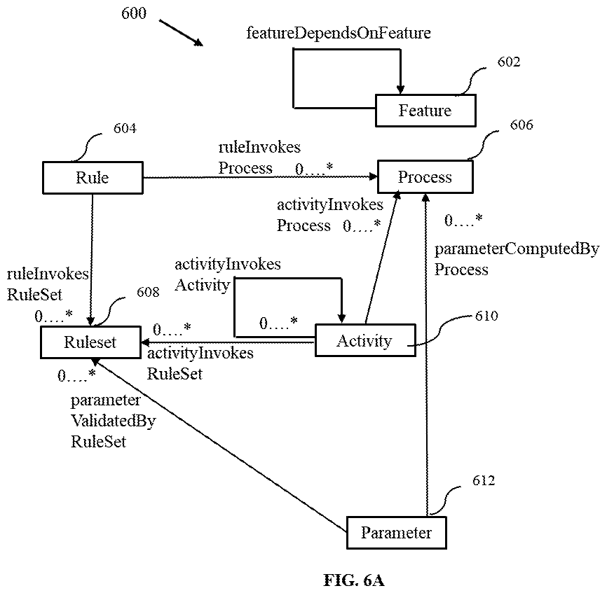

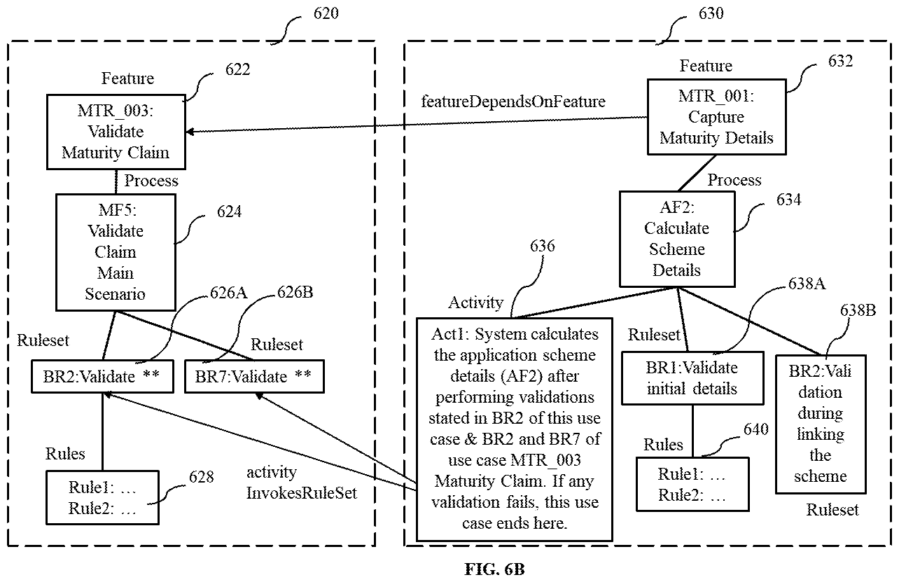

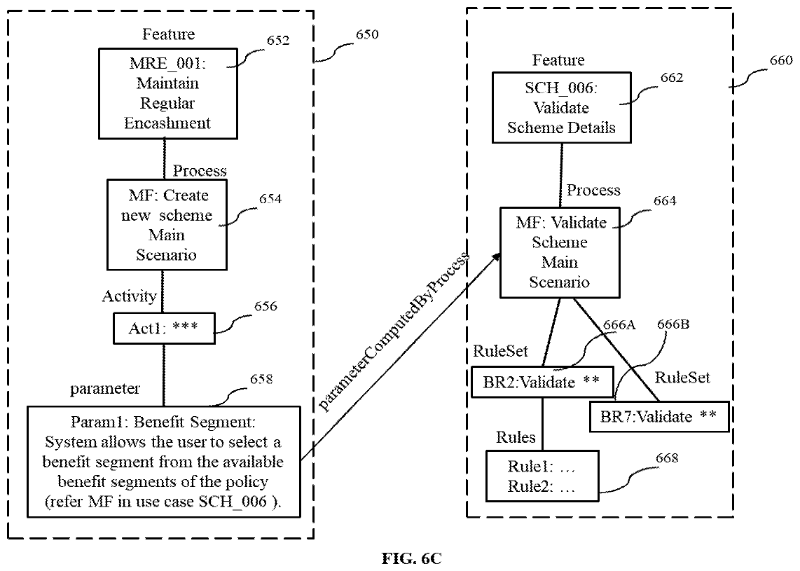

FIG. 6A illustrates example dependency associations for the processor implemented method for feature specification and dependency extraction from requirement specification documents implemented by the system of FIG. 1, in accordance with some embodiments of the present disclosure. Now referring to FIG. 6A, the dependency model 600 includes a feature element 602, a rule element 604, a process element 606, a ruleset element 608, an activity element 610 and a parameter element 612. The dependency association for the feature element 602 to itself is “featureDependsOnFeature”. The rule element 604 is having a dependency association “ruleInvokesProcess” with the process element 606. Further, the rule element 604 is having a dependency association “ruleInvokesRuleSet” with the ruleset element 608. The activity element 610 is having a plurality of dependency associations including “activityInvokesRuleSet” with the ruleset element 608, “activityinvokesActivity” with itself and “activityInvokesProcess” with the process element 606. The parameter element 612 is having a plurality of dependency associations including “parameterValidatedByRuleSet” with the ruleset element 608 and “parameterComputedByProcess” with the process element 606.

FIG. 6B illustrates example dependency associations for the feature “Capture maturity details” and its corresponding specification model on the feature “Validate maturity claim” and its corresponding specification model for the processor implemented method for feature specification and dependency extraction from requirement specification documents implemented by the system of FIG. 1, in accordance with some embodiments of the present disclosure. Now referring to FIG. 6B, the example includes two specification models 620 for the feature “MTR_003: Validate Maturity Claim” and 630 for the feature “MTR_001: Capture Maturity Details”. The specification model 620 includes a feature element “MTR_003: Validate Maturity Claim” 622, a process element “MF5: Validate Claim Main Scenario” 624, a plurality of ruleset elements including “BR2: Validate**” 626A and “BR7: Validate**” 626B. The ruleset “BR2: Validate**” 626A is associated with a plurality of rules element 628. Here, “MTR_003” is the ID for the feature “Validate Maturity Claim”. The “MTR_001” is the ID for “Capture Maturity Details”. “MF5” is the ID for process “Validate Claim Main Scenario”. Similarly, “BR2” and “BR7” are the IDs of Business Ruleset for the process 624.

The specification model 630 of FIG. 6B includes a feature element “MTR_001: Capture Maturity Details” 632, a process element “AF2: Calculate Scheme Details” 634, a plurality of ruleset elements including “BR1: Validate initial details” 638A and “BR2: Validation during linking the scheme” 638B. The ruleset element “BR1: Validate initial details” 638A is associated with a plurality of rule elements 640. The process element “AF2: Calculate Scheme Details” 634 is associated with an activity element 636. The activity element 636 is holding an activity “System calculates the application scheme details after performing validations stated in BR2 and BR7 of the use case MTR_003 Maturity Claim, If any validation fails, this use case ends here”. As per activity description text there is reference of feature and also rules of the feature. Hence the feature element “MTR_001: Capture Maturity Details” 632 of the specification model 630 is having a dependency association “featureDependsOnFeature” with the feature element “MTR_003: Validate Maturity Claim” 622 of the dependency model 620 and, the activity element 636 of the specification model 630 is having a dependency associations “activityInvokesRuleSet” with the ruleset elements “BR2: Validate**” 626A and “BR7: Validate**” 626B of the specification model 620.

FIG. 6C illustrates example dependency associations between two features or two specification models “Maintain Regular Encashment” and “Validate Scheme Details” for the processor implemented method for feature specification and dependency extraction from requirement specification documents implemented by the system of FIG. 1, in accordance with some embodiments of the present disclosure. Now referring to FIG. 6C, the example includes two specification models 650 for the feature “MRE_001: Maintain Regular Encashments” and 660 for the feature “SCH_006: Validate Scheme Details”. The specification model 650 includes a feature element “MRE_001: Maintain Regular Encashments” 652, a process element “MF: Create New Scheme Main Scenario” 654, an activity element 656 and a parameter element “Param1: Benefit segment: System allows user to select a benefit segment from the available benefit segments of the policy”. The specification model 660 includes a feature element “SCH_006: Validate Scheme Details” 662, a process element “MF: Validate Scheme Main Scenario” 654, a plurality of ruleset elements including “BR2: Validate**” 666A and “BR7: Validate**” 666B. The ruleset element “BR2: Validate**” 666A is associated with a plurality of rules element 668. Here, the parameter element 658 of the specification model 650 is having a dependency association “parameterComputedByProcess” with the process element “MF: Validate Main Scenario” 664, which means, the parameters element 656 of the specification model 650 is computed by the process 664 of the specification model 660.

At step 210 of the method 200, the one or more hardware processors 102 are configured by the programmed instructions to update the plurality of dependency associations in the corresponding specification model by traversing the specification models.

For example, now referring to the FIG. 6B, the plurality of dependency associations identified by the dependency association extraction technique are “featureDependOnFeature” for the feature 632 on the feature 622. Further, the “activityInvokesRuleSet” is identified for the activity 636 of the specification model 630 and on the Rulesets 626A and 626B of the specification model 620. The extracted dependency associations for a specification model is updated by traversing the corresponding specification model. In this example, there is an identified dependency association “featureDependOnFeature” for the feature 632 of the specification model 630 and on the feature 622 of the specification model 620. Hence an association “featureDependOnFeature” is created between the feature 632 of the specification model 630 and the feature 622. There is an identified dependency association “activityInvokesRuleSet” from the activity 636 of the specification model 630 on the Rulesets 626A and 626B of the specification model 620. Hence the dependency association “activityInvokesRuleSet” is created between 636 of the specification model 630 and the Ruleset 626A of the specification model 620. Similarly, another dependency association “activityInvokesRuleSet” is created between 636 of the specification model 630 and the Ruleset 626B of the specification model 620.

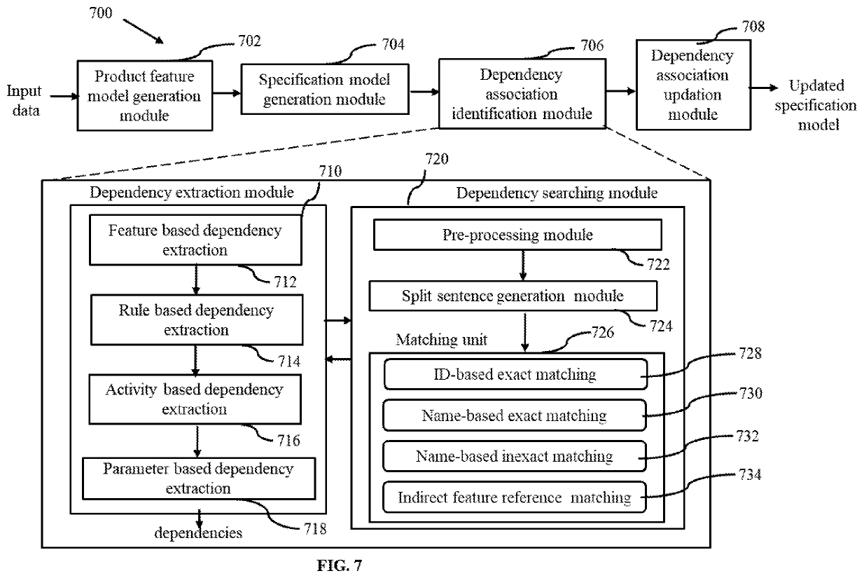

FIG. 7 illustrates a functional architecture for the processor implemented method for feature specification and dependency extraction from requirement specification documents implemented by the system of FIG. 1, in accordance with some embodiments of the present disclosure. Now referring to FIG. 7, the functional architecture 700 includes a product feature model generation module 702, a specification model generation module 704, a dependency association identification module 706 and a dependency association updation module 708. The input data including the plurality of requirement specification documents, the plurality of extraction patterns and the domain dictionary are received initially. The product feature model generation module 702 generates the product feature model. The product feature model includes the plurality of features arranged hierarchically. The plurality of product feature elements comprises a feature area, a major feature and a plurality of features. The specification model generation module 704 generates the specification model for each of the plurality of features associated with the product feature model using the specification extraction technique. The specification model includes the plurality of specification elements and the plurality of corresponding associations. The plurality of specification elements includes the plurality of processes, the plurality of activities, the plurality of rulesets, the plurality of rules and the plurality of parameters. The dependency association identification module 706 generates the plurality of dependency associations for each of the plurality of specification elements based on the corresponding specification model using the dependency extraction technique. The plurality of dependencies associations includes the featureDependsOnFeature dependency, the activityInvokesProcess dependency, the activityInvokesActivity dependency, the activityInvokesRuleSet dependency, the ruleInvokesProcess dependency, the ruleInvokesRuleSet dependency, the parameterComputedByProcess dependency, and the parameterValidatedByRuleSet dependency. The dependency association updation module 708 updates the plurality of dependency associations in the corresponding specification model.

In an embodiment, dependency association identification module 706 of FIG. 7 includes a dependency extraction module 710 and a dependency searching module 720. The dependency extraction module 710 includes a feature based dependency extraction unit 712, a rule based dependency extraction unit 714, an activity based dependency extraction unit 716 and a parameter based dependency extraction unit 718. The feature based dependency extraction unit 712 extracts a plurality of feature based dependencies including featureDependsOnFeature using the dependency searching module 720. The rule based dependency extraction unit 714 extracts a plurality of rule based dependencies including the ruleInvokesProcess dependency and the ruleInvokesRuleSet using the dependency searching module 720. The activity based dependency extraction unit 716 extracts a plurality of activity based dependencies including the activityInvokesProcess dependency, the activityInvokesActivity dependency and the activityInvokesRuleSet using the dependency searching module 720. The parameter based dependency extraction unit 718 extracts a plurality of parameter based dependencies including the parameterComputedByProcess dependency, and the parameterValidatedByRuleSet dependency using the dependency searching module 720.

The dependency search module 720 of FIG. 7 includes a preprocessing module 722, a split sentence generation module 724 and the matching unit 726. The preprocessing module 722 preprocesses the plurality of descriptions corresponding to each of the plurality of specification elements. The split sentence generation module 724 obtaining the plurality of split sentences corresponding to the specification model by splitting the description of each of the plurality of specification elements. The matching unit 726 identifies the plurality of dependencies associated with each of the plurality of specification elements based on the plurality of split sentences using a plurality of matching techniques. The plurality of matching techniques includes the ID based exact matching 728, the name based exact matching 730, the name based inexact matching 732 and an indirect feature reference matching 734.

The dependency association updation module 708 of FIG. 7 updates the plurality of dependencies corresponding to each of the plurality of specification elements in the specification model by traversing the specification model.

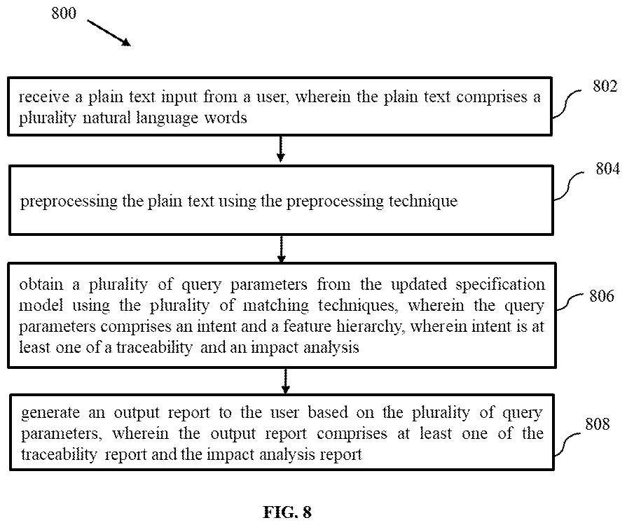

FIG. 8 is an example flow diagram for query processing and output report generation for the processor implemented method for feature specification and dependency extraction from requirement specification documents implemented by the system of FIG. 1, in accordance with some embodiments of the present disclosure.

In an embodiment, the system 100 further comprises generating an output report to the user. Now referring to FIG. 8, at step 802, a plain text input from a user is received. The plain text includes a plurality natural language words. At step 804, the plain text is preprocessed using the document engine parsing technique. At step 806, a plurality of query parameters are obtained from the updated specification model using the plurality of matching techniques. The query parameters includes an intent and a feature hierarchy, wherein intent is at least one of a traceability and an impact analysis. At step 808, the output report to the user is generated based on the plurality of query parameters. The output report includes at least one of the traceability report and the impact analysis report. An example traceability report is shown in table I and an example impact analysis report is shown in table II.

TABLE I

| Feature | | Feature | | Validation | |
|---|---|---|---|---|---|
| Area | feature | Type | Processes | Rulesets | Dependencies |
| SCHEME | (SCH_001) | IO | (MF) Create | (BR1) Validation | Feature |
| ADMINISTRATION | Create | Function | New | initial details | Dependences: |
| | New | | Scheme | ruleset | 1. (SCH: 006) |
| | Scheme | | Main | (BR2) Validation | Validate |
| | | | Scenario | during linking the | scheme |
| | | | (AF1) User | scheme | details |
| | | | Action for | (Number/Category/ | Ruleset |
| | | | scheme | Policy/Contributor | dependencies: |
| | | | (AF2) Save | Type/Benefit | 1. SCH_006_BR2 |
| | | | initial | Ruleset | 2. SCH_006_BR7 |
| | | | scheme | (BR3) Validate | |
| | | | details | bank details | |
| | | | (AF3) | ruleset | |
| | | | Authorize | (BR4)Validate | |
| | | | new scheme | complete | |
| | | | (AF4) | scheme ruleset | |
| | | | Generate | | |
| | | | scheme for | | |
| | | | third party | | |

Now referring to table I, table I shows the traceability report for the feature “Create New Scheme” with ID “SCH_001” of feature area SCHEME ADMINISTRATION. The complete traceability mapping of the feature: feature->process->ruleset->feature dependencies is automatically generated by the system. The feature has five processes, “Create New Scheme Main Scenario” is the main process and others are subprocesses. This feature has five validation rulesets that are invoked from activities. The last column of the Traceability sheet shows different type of dependencies. As shown, the example feature depends on the feature “Validate Scheme Details” with ID “SCH_006” for the BR2 and BR7 rules.

TABLE II
Changing feature details: SCH_006- Validate scheme details

Impacted features:
1. (IOFunction) SCH_001 - Create new Scheme
2. (IOFunction) MRE_001 - Maintain Regular Encashment
3. (IOFunction) SCH_007 - Maintain Scheme Details
Impacted activities due to SCH_006 process change:
1. (Process)SCH_006_AF2=> (Activity) SCH_001_AF1.2
Impacted parameters due to SCH_006 process change:
1. (Process)SCH_006_AF4 => (Parameter)MRE_001_Benefit Segment
Impacted Activities due to SCH_006 ruleset change:
1. (RuleSet)SCH_006_BR2 => (Activity)SCH_001_AF1.2
2. (RuleSet)SCH_006_BR7 => (Activity)SCH_001_AF1.2
3. (RuleSet)SCH_006_BR7 => (Activity)SCH_007_AF1.2

Now referring to table II, table II shows the impact analysis report for the feature ‘Validate Scheme Details’ with ID ‘SCH_006’ of feature area SCHEME ADMINISTRATION. Feature change may involve a change of process, activity, or ruleset. Each of these changes results in a direct or indirect impact on other activities or parameters where it is referenced.

In an embodiment, the system 100 has been tested with a sample input and the results of testing is given in table III and table IV. The table III illustrates the name and number of the plurality of feature areas, the feature count, the process count, the activity count, the RuleSet count, the rule count and the parameter count corresponding to each of the plurality of feature areas.

TABLE III

| Feature | | | | | | |
|---|---|---|---|---|---|---|
| Area | Feature | Process | Activity | RuleSet | Rule | Parameter |
| Name | count | count | count | count | count | count |
| FA1 | 57 | 86 | 489 | 40 | 124 | 1133 |
| FA2 | 104 | 200 | 1368 | 93 | 425 | 2490 |
| FA3 | 158 | 325 | 1623 | 128 | 286 | 2445 |
| FA4 | 25 | 58 | 304 | 28 | 81 | 788 |
| FA5 | 20 | 22 | 81 | 8 | 11 | 59 |
| FA6 | 324 | 648 | 2881 | 264 | 576 | 6772 |
| FA7 | 34 | 38 | 347 | 10 | 12 | 514 |
| Total | 722 | 1377 | 7093 | 571 | 1515 | 14201 |

Table IV illustrates the number of dependency associations extracted by the system 100 for the sample input.

TABLE IV

| feature | | | | | | | |
|---|---|---|---|---|---|---|---|
| Depends | activity | activity | activity | rule | rule | parameter | parameter |
| On | Invokes | Invokes | Invokes | Invokes | Invokes | Computed | Validated |
| Feature | Process | Activity | RuleSet | Process | RuleSet | ByProcess | ByRuleSet |
| 1128 | 759 | 19 | 77 | 41 | 16 | 115 | 20 |

In an embodiment, the output generated by the system 100 has been validated as explained below: Each element of the specification model is validated for accuracy of extraction, and a score is given on a scale of 0 to 1, 1 being 100% accurate model extraction and 0 being inaccurate extraction. The extraction accuracy of the system 100 is computed using Formulae 1 through 5 and the extraction accuracy of the system 100 is shown in Table V.

$$\begin{matrix}Activity extraction accuracy = \frac{Σ ( Activity Score )}{Σ ( Features Validated )} & ( 1 ) \\ Rules extraction accuracy = \frac{Σ ( Rules Score )}{Σ ( Features Validated )} & ( 2 ) \\ Parameter extraction accuracy = \frac{Σ ( Parameter Score )}{Σ ( Features Validated )} & ( 3 ) \\ Dependency extraction accuracy = \frac{Σ ( Dependency Score )}{Σ ( Features Validated )} & ( 4 ) \\ Overall extraction accuracy = Average ( \begin{matrix}Activity extraction accuracy , \\ Rules extraction accuracy , \\ Parameter extraction accuracy , \\ Dependency extraction accuracy\end{matrix} ) & ( 5 )\end{matrix}$$

TABLE V

| Extraction type | Extraction accuracy |
|---|---|
| Processes and Activities | 96% |
| RuleSets and Rules | 99% |
| Parameters | 100% |
| Dependencies | 89% |
| | 96% |

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments of present disclosure herein address the unresolved problem of automatic extraction of specification model and the dependency model for each feature of the requirement specification document. Further, the present disclosure is capable of generating a traceability report and impact analysis report for any feature. This increases the accuracy and reduces time in software development lifecycle which includes a number of iterations.

It is to be understood that the scope of the protection is extended to such a program and in addition to a computer-readable means having a message therein such computer-readable storage means contain program-code means for implementation of one or more steps of the method when the program runs on a server or mobile device or any suitable programmable device. The hardware device can be any kind of device which can be programmed including e.g. any kind of computer like a server or a personal computer, or the like, or any combination thereof. The device may also include means which could be e.g. hardware means like e.g. an application-specific integrated circuit (ASIC), a field-programmable gate array (FPGA), or a combination of hardware and software means, e.g. an ASIC and an FPGA, or at least one microprocessor and at least one memory with software modules located therein. Thus, the means can include both hardware means and software means. The method embodiments described herein could be implemented in hardware and software. The device may also include software means. Alternatively, the embodiments may be implemented on different hardware devices, e.g. using a plurality of CPUs, GPUs and edge computing devices.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer readable medium can be any apparatus that can comprise, store, communicate, propagate, or transport the program for use by or in connection with the instruction execution system, apparatus, or device. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments. Also, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e. non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A processor implemented method, the method comprising:
receiving, by one or more hardware processors, a plurality of requirement specification documents, a plurality of extraction patterns, and a domain dictionary;
generating, by the one or more hardware processors, a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features;
generating, by the one or more hardware processors, a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters;
generating, by the one or more hardware processors, a plurality of dependency associations for each of the plurality of specification elements based on the corresponding specification model using a dependency extraction technique; and
updating, by the one or more hardware processors, the plurality of dependency associations in the corresponding specification model.

2. The processor implemented method of claim 1, wherein the plurality of extraction patterns comprises a process pattern, an activity pattern, a parameter pattern, a ruleset pattern and a rule pattern, wherein each of the plurality of extraction patterns comprises a corresponding plurality of document formatting styles and, wherein the domain dictionary comprises a plurality of taxonomical variations of domain terms.

3. The processor implemented method of claim 1, wherein each of the plurality of specification elements of the specification model comprises a plurality of properties, wherein the plurality of properties comprises an ID, a name, and a description.

4. The processor implemented method of claim 1, wherein the method of generating the specification model for each of the plurality of features using the specification extraction technique comprises:
receiving the plurality features and the plurality of requirement specification documents;
extracting a plurality of text content from the plurality of requirement specification documents by parsing the plurality of requirement specification documents using a document engine parsing technique;
generating a feature element corresponding to each of the plurality of features;
extracting a plurality of processes corresponding to each of the plurality of features based on a comparison between the plurality of text content and the plurality of process patterns;
generating a process element corresponding to each of the plurality of processes;
generating an association between each of a plurality of feature elements and each of a plurality of corresponding process elements;
extracting a plurality of subprocesses corresponding to each of the plurality of processes based on a comparison between the plurality of text content and the plurality of process patterns;
generating a subprocess element corresponding to each of the plurality of subprocesses;
generating an association between each of a plurality of process elements and each of a plurality of corresponding subprocess elements;
extracting a plurality of activities corresponding to each of the plurality of subprocesses based on a comparison between the plurality of text content and a plurality of activity patterns;
generating an activity element corresponding to each of the plurality of activities;
generating an association between each of a plurality of subprocess elements and each of a plurality of corresponding activity elements;
extracting a plurality of parameters corresponding to each of the plurality of activities based on a comparison between plurality of text content and a plurality of parameter patterns;
generating a parameter element corresponding to each of a plurality of parameters;
generating an association between each of a plurality of activity elements and each of the plurality of corresponding parameter elements;
extracting a plurality of rulesets corresponding to each of the plurality of features based on a comparison between plurality of text content and a plurality of ruleset patterns;
generating a plurality of ruleset elements corresponding to each of the plurality of rules sets;
generating an association between each of a plurality of process elements and each of the plurality of corresponding ruleset elements;
extracting a plurality of rules corresponding to each of the plurality of ruleset based on a comparison between the plurality of text content and a plurality of rule patterns;
generating a rule element for the plurality of rules; and
generating an association between the rule element and the corresponding ruleset element.

5. The processor implemented method of claim 1, wherein the method of generating the plurality of dependency associations for each of the plurality of specification elements based on the corresponding specification model using the dependency extraction technique comprises:
receiving the specification model corresponding to each of the plurality of features;
identifying a plurality of dependencies associated with each of the plurality of specification elements based on the corresponding plurality of properties using a dependency searching technique by:
preprocessing the description corresponding to each of the plurality of specification elements;
obtaining a plurality of split sentences corresponding to the specification model by splitting the description of each of the plurality of specification elements; and
identifying the plurality of dependencies associated with each of the plurality of specification elements based on the plurality of split sentences using a plurality of matching techniques, wherein the plurality of matching techniques comprises the ID based exact matching, a name based exact matching, name based inexact matching and an indirect feature reference matching; and
updating the plurality of dependencies corresponding to each of the plurality of specification elements in the specification model by traversing the specification model.

6. The processor implemented method of claim 5, wherein the method of preprocessing comprises:
receiving the input data, wherein the input data is one of, the description corresponding to each of the plurality of specification elements and a plain text input from a user;
obtaining a parsed data by removing a plurality of stop words associated with the input data using a parsing technique;
obtaining a root form for each of a plurality of words associated with the parsed data using a Natural Language Processing (NLP) technique;
simultaneously identifying a plurality of dictionary terms from the parsed data; and
swapping each of the plurality of dictionary terms associated with the parsed data with a corresponding common name using the domain dictionary.

7. The processor implemented method of claim 5, wherein the ID based exact matching technique compares the ID associated with each of the plurality of specification elements with the plurality of split sentences corresponding to each of the plurality of specification elements, wherein the name based exact matching technique compares the name associated with each of the plurality of specification elements with the plurality of split sentences corresponding to each of the plurality of specification elements by considering the ordering of words and, wherein the name based inexact matching technique compares the name associated with each of the plurality of specification elements with the plurality of split sentences corresponding to each of the plurality of specification elements without considering the ordering of words.

8. The processor implemented method of claim 5, wherein the indirect feature reference matching technique compares preprocessed description with a plurality of referential words, wherein each of the plurality of referential words comprises a plurality of feature reference patterns and, wherein each of the plurality of feature reference patterns comprises a corresponding plurality of referencing styles.

9. The processor implemented method of claim 1, further comprises generating an output report to the user, by:
receiving the plain text input from the user, wherein the plain text comprises a plurality natural language words;
preprocessing the plain text using the preprocessing technique;
obtaining a plurality of query parameters from the updated specification model using the plurality of matching techniques, wherein the query parameters comprises an intent and a feature hierarchy, wherein intent is at least one of a traceability and an impact analysis; and
generating the output report to the user based on the plurality of query parameters, wherein the output report comprises at least one of the traceability report and the impact analysis report.

10. A system comprising:
at least one memory storing programmed instructions; one or more Input/Output (I/O) interfaces; and one or more hardware processors operatively coupled to the at least one memory , wherein the one or more hardware processors are configured by the programmed instructions to:
receive a plurality of requirement specification documents, a plurality of extraction patterns, and a domain dictionary;
generate a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features;
generate a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters;
generate a plurality of dependency associations for each of the plurality of specification elements based on the corresponding specification model using a dependency extraction technique; and
update the plurality of dependency associations in the corresponding specification model.

11. The system of claim 10, wherein the plurality of extraction patterns comprises a process pattern, an activity pattern, a parameter pattern, a ruleset pattern and a rule pattern, wherein each of the plurality of extraction patterns comprises a corresponding plurality of document formatting styles and, wherein the domain dictionary comprises a plurality of taxonomical variations of domain terms.

12. The system of claim 10, wherein each of the plurality of specification elements of the specification model comprises a plurality of properties, wherein the plurality of properties comprises an ID, a name, and a description.

13. The system of claim 10, wherein the method of generating the specification model for each of the plurality of features using the specification extraction technique comprises:
receiving the plurality features and the plurality of requirement specification documents;
extracting a plurality of text content from the plurality of requirement specification documents by parsing the plurality of requirement specification documents using a document engine parsing technique;
generating a feature element corresponding to each of the plurality of features;
extracting a plurality of processes corresponding to each of the plurality of features based on a comparison between the plurality of text content and the plurality of process patterns;
generating a process element corresponding to each of the plurality of processes;
generating an association between each of a plurality of feature elements and each of a plurality of corresponding process elements;
extracting a plurality of subprocesses corresponding to each of the plurality of processes based on a comparison between the plurality of text content and the plurality of process patterns;
generating a subprocess element corresponding to each of the plurality of subprocesses;
generating an association between each of a plurality of process elements and each of a plurality of corresponding subprocess elements;
extracting a plurality of activities corresponding to each of the plurality of subprocesses based on a comparison between the plurality of text content and a plurality of activity patterns;
generating an activity element corresponding to each of the plurality of activities;
generating an association between each of a plurality of subprocess elements and each of a plurality of corresponding activity elements;
extracting a plurality of parameters corresponding to each of the plurality of activities based on a comparison between plurality of text content and a plurality of parameter patterns;
generating a parameter element corresponding to each of a plurality of parameters;
generating an association between each of a plurality of activity elements and each of the plurality of corresponding parameter elements;
extracting a plurality of rulesets corresponding to each of the plurality of features based on a comparison between plurality of text content and a plurality of ruleset patterns;
generating a plurality of ruleset elements corresponding to each of the plurality of rules sets;
generating an association between each of a plurality of process elements and each of the plurality of corresponding ruleset elements;
extracting a plurality of rules corresponding to each of the plurality of ruleset based on a comparison between the plurality of text content and a plurality of rule patterns;
generating a rule element for the plurality of rules; and
generating an association between the rule element and the corresponding ruleset element.

14. The system of claim 10, wherein the method of generating the plurality of dependency associations for each of the plurality of specification elements based on the corresponding specification model using the dependency extraction technique comprises:
receiving the specification model corresponding to each of the plurality of features;
identifying a plurality of dependencies associated with each of the plurality of specification elements based on the corresponding plurality of properties using a dependency searching technique by:
preprocessing the description corresponding to each of the plurality of specification elements;
obtaining a plurality of split sentences corresponding to the specification model by splitting the description of each of the plurality of specification elements; and
identifying the plurality of dependencies associated with each of the plurality of specification elements based on the plurality of split sentences using a plurality of matching techniques, wherein the plurality of matching techniques comprises the ID based exact matching, a name based exact matching, name based inexact matching and an indirect feature reference matching; and
updating the plurality of dependencies corresponding to each of the plurality of specification elements in the specification model by traversing the specification model.

15. The system of claim 14, wherein the method of preprocessing comprises:
receiving the input data, wherein the input data is one of, the description corresponding to each of the plurality of specification elements and a plain text input from a user;
obtaining a parsed data by removing a plurality of stop words associated with the input data using a parsing technique;
obtaining a root form for each of a plurality of words associated with the parsed data using a Natural Language Processing (NLP) technique;
simultaneously identifying a plurality of dictionary terms from the parsed data; and
swapping each of the plurality of dictionary terms associated with the parsed data with a corresponding common name using the domain dictionary.

16. The system of claim 14, wherein the ID based exact matching technique compares the ID associated with each of the plurality of specification elements with the plurality of split sentences corresponding to each of the plurality of specification elements, wherein the name based exact matching technique compares the name associated with each of the plurality of specification elements with the plurality of split sentences corresponding to each of the plurality of specification elements by considering the ordering of words and, wherein the name based inexact matching technique compares the name associated with each of the plurality of specification elements with the plurality of split sentences corresponding to each of the plurality of specification elements without considering the ordering of words.

17. The system of claim 14, wherein the indirect feature reference matching technique compares preprocessed description with a plurality of referential words, wherein each of the plurality of referential words comprises a plurality of feature reference patterns and, wherein each of the plurality of feature reference patterns comprises a corresponding plurality of referencing styles.

18. The system of claim 10, further comprises generating an output report to the user, by:
receiving the plain text input from the user, wherein the plain text comprises a plurality natural language words;
preprocessing the plain text using the preprocessing technique;
obtaining a plurality of query parameters from the updated specification model using the plurality of matching techniques, wherein the query parameters comprises an intent and a feature hierarchy, wherein intent is at least one of a traceability and an impact analysis; and
generating the output report to the user based on the plurality of query parameters, wherein the output report comprises at least one of the traceability report and the impact analysis report.

19. One or more non-transitory machine-readable information storage mediums comprising one or more instructions which when executed by one or more hardware processors causes:
receiving a plurality of requirement specification documents, a plurality of extraction patterns, and a domain dictionary;
generating a product feature model based on the plurality of requirement specification documents, the plurality of extraction patterns, and the domain dictionary, using a feature model generation technique, wherein the product feature model comprises a plurality of features elements arranged hierarchically, wherein the plurality of product feature elements comprises a feature area, a major feature, and a plurality of features;
generating a specification model for each of the plurality of features associated with the product feature model using a specification extraction technique, wherein the specification model comprises a plurality of specification elements and a plurality of corresponding associations, wherein the plurality of specification elements comprises a plurality of processes, a plurality of activities, a plurality of rulesets, a plurality of rules and a plurality of parameters;
generating a plurality of dependency associations for each of the plurality of specification elements based on the corresponding specification model using a dependency extraction technique; and
updating the plurality of dependency associations in the corresponding specification model.
